(19) United States
(12) Patent Application Publication
(10) Pub. No.: US 2012/0260037 A1
(43) Pub. Date: Oct. 11, 2012

(54) SMART HYBRID STORAGE BASED ON INTELLIGENT DATA ACCESS CLASSIFICATION

(76) Inventors: Mahmoud K. Jibbe, Wichita, KS (US); Senthil Kannan, RediyarPalayam (IN); Britto Rossario, Bangalore (IN)

(21) Appl. No.: 13/083,804

(22) Filed: Apr. 11, 2011

(51) Int. Cl. G06F 12/00; G06F 12/16

(52) U.S. Cl. 711/114; 711/170; 711/E12.001; 711/E12.103

(57) ABSTRACT

A method for configuring resources in a storage array, comprising the steps of (a) determining if a data access is a first type or a second type, (b) if the data access is the first type, configuring the storage array as a reliable type configuration, (c) if the data access is the second type, configuring the storage array as a secure type configuration.

### FIELD OF THE INVENTION

The present invention relates to data storage generally and, more particularly, to a method and/or apparatus for implementing a smart hybrid storage based on intelligent data access classification.

### BACKGROUND OF THE INVENTION

In conventional storage arrays, data storage specifications are classified into 3 major categories including (i) mission-critical data, high performance or sensitive data, (ii) reliable data or (iii) reliable and sensitive data.

Mission-critical data, high performance or sensitive data is used in key business processes or customer applications. Such data typically has a very fast response time specification. The data is transactional data having a high input/output process (i.e., IOP) performance with optimal and/or moderate reliability.

Reliable data is classified as company confidential data. Reliable data does not have an instantaneous recovery criteria for the business to remain in operation. The redundancy of such confidential data is important as data should be available under all conditions.

Data that is both reliable and sensitive uses both a high IOP performance and a highly reliable storage technology. Conventional storage systems are challenged to effectively move data between the three categories of storage based on the dynamic input/output load specifications in a storage area network (i.e., SAN).

It would be desirable to implement a hybrid storage system that considers performance to cost impact to dynamically allocate high IOP drives efficiently based on user needs.

### SUMMARY OF THE INVENTION

The present invention concerns a method for configuring resources in a storage array, comprising the steps of (a) determining if a data access is a first type or a second type, (b) if the data access is the first type, configuring the storage array as a reliable type configuration, (c) if the data access is the second type, configuring the storage array as a secure type configuration.

The objects, features and advantages of the present invention include providing smart hybrid storage that may (i) be based on intelligent data access classification, (ii) drive group or volume group creation based on classified data access criteria of a user, (iii) use vendor unique bits in a control byte of a small computer system interface command descriptor block (e.g., (SCSI CDB) for input/output classification and input/output routing, (iv) provide intelligent data access pattern learn logic to dynamically allocate a solid state device drive or a group of solid state device drives to one or more hard disk groups based on the input/output load, (v) use a control byte of a small computer system interface command descriptor block by the intelligent data access pattern learn logic to initialize a track of an input/output load increase for any particular category of drive groups and track the data flow pattern, and/or (vi) provide automatic de-allocation of drives if the input/output load or data demand has reduced for any particular disk drive groups.

### BRIEF DESCRIPTION OF THE DRAWINGS

These and other objects, features and advantages of the present invention will be apparent from the following detailed description and the appended claims and drawings in which:

FIG. 1 is a block diagram illustrating a context of the present invention;

FIG. 2 is a block diagram illustrating a reliable configuration of a storage system;

FIG. 3 is a block diagram illustrating a sensitive data configuration of a storage system;

FIG. 4 is a block diagram of an input/output transaction through an input/output path virtualization layer;

FIG. 5 is a block diagram of an example of a set of vendor unique bits;

FIG. 6 is a block diagram of an input/output transaction using a solid state device as an individual drive;

FIG. 7 is a block diagram of an input/output transaction using a solid state device for a disk drive group to implement a performance boost;

FIG. 8 is a block diagram of an input/output transaction using a solid state drive for a mirror disk drive group;

FIG. 9 is a block diagram of an input/output transaction using a solid state drive for an individual disk drive and a mirror disk drive group to implement a performance boost; and

FIG. 10 is a flow diagram illustrating an example of the present invention.

### DETAILED DESCRIPTION OF THE PREFERRED EMBODIMENTS

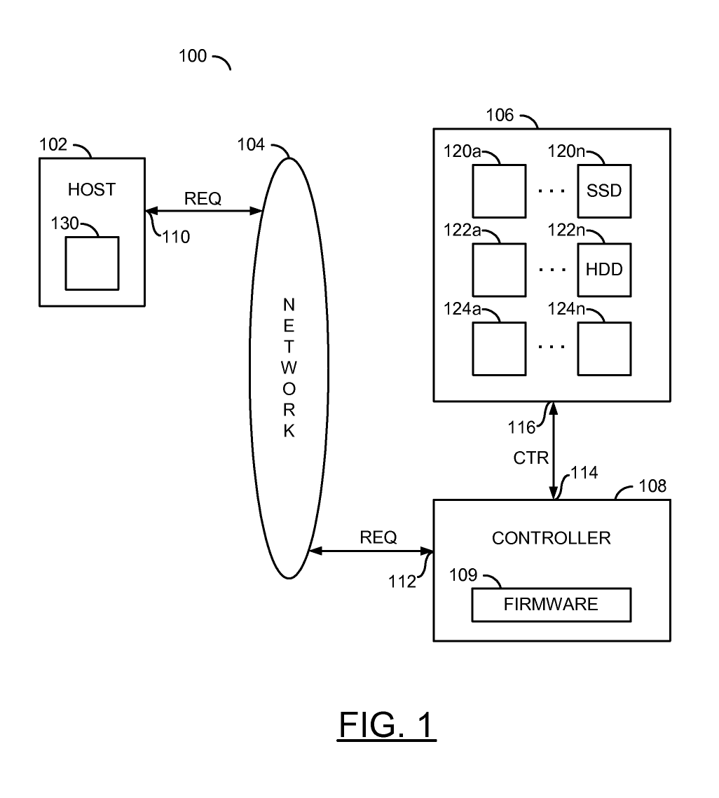

Referring to FIG. 1, a block diagram of a system 100 is shown illustrating a context of the present invention. The system 100 generally comprises a block (or circuit) 102, a network 104, a block (or circuit) 106 and a block (or circuit) 108. The circuits 102 to 108 may represent modules and/or blocks that may be implemented as hardware, software, a combination of hardware and software, or other implementations.

The circuit 102 may be implemented as a host. The host 102 may be implemented as one or more computers (or servers or processors) in a host/client configuration. The circuit 106 may be implemented as a number of storage devices (e.g., a drive array). The circuit 108 may be implemented as a controller (e.g., an array controller). In one example, the circuit 108 may be a redundant array of independent disks (e.g., RAID) controller. The circuit 108 may include a block (or module, or circuit) 109. The block 109 may be implemented as firmware (or software or program instructions or code) that may control the controller 108.

The host 102 may have an input/output 110 that may present a signal (e.g., REQ). A configuration file 130 may be sent via the signal REQ through the network 104 to an input/output 112 of the controller 108. The controller 108 may have an input/output 114 that may present a signal (e.g., CTR) to an input/output 116 of the storage array 106.

The array 106 may have a number of storage devices (e.g., drives or volumes) 120a-120n, a number of storage devices (e.g., drives or volumes) 122a-122n and a number of storage devices (e.g., drives or volumes) 124a-124n. In an example, each of the storage devices 120a-120n, 122a-122n, and 124a-124n may be implemented as a single drive, multiple drives, and/or one or more drive enclosures. The storage devices 120a-120n, 122a-122n and/or 124a-124n may be implemented as one or more hard disc drives (e.g., HDDs), one or more solid state devices (e.g., SSDs) or a combination of HDDs and SSDs.

The system 100 may implement a data access classification scheme to determine whether a particular data access should use high performance processing, high reliability storage and/or a mix of both. The system 100 may efficiently allocate data storage in the array 106 using the controller 108. A number of bytes (e.g., SCSI CDB bytes) may be modified to detect a data class and/or allocate high reliability storage (e.g., solid state device storage versus hard disk drive storage) on the fly (e.g., without rebooting the controller 108).

The system 100 may process data using high performance processing and/or high reliability storage by dynamically determining an active data block access and/or a pattern received from the host 102. The controller firmware 109 may implement an intelligent data pattern learn logic engine with smart data access classification. One or more of the solid state device drives (e.g., the drives 120a-120n) may be attached to the controller 108 to form volumes, groups or disks based on a number of implementation options. The system 100 may provide a hybrid storage system with a combination of hard disk drives 122a-122n and/or solid state drives 120a-120n to dynamically enhance the performance of the storage subsystem based on the input/output loads.

The system 100 may further provide an option to create and/or allocate storage based on storage criteria and/or data access classification (e.g., high sensitive data versus high reliable storage). Data that uses both reliable storage and high performance processing may be implemented dynamically by attaching one or more of the solid state drives 120a-120n to the array 106. An intelligent data access learning module may be implemented in the controller firmware 109 to monitor the data accesses and the active data blocks per unit time. The process of attaching and de-attaching the solid state drives 120a-120n may be based on the controller 108 (i) mapping the active data blocks accessed and the solid state drives 120a-120n and (ii) modifying the small computer system interface (e.g., SCSI) command descriptor block (e.g., CDB). The writes may be directed to the hard disk drives 122a-122n and the reads may be performed via the solid state drives 120a-120n. The drives 122a-122n and the drives 120a-120n may be asynchronously accessed.

The modes of operation of the system 100 and a flow may be described as follows. A user is generally provided an option to select a drive group or volume group based on data access classification such as (i) the data that uses reliable storage and high redundancy, (ii) the data that uses storage which may be sensitive and transactional (e.g., the storage may be implemented with fast drives and high input/output processes) and/or (iii) the data that uses high input/output processes and reliable storage with high redundancy. An administrator (or operator or technician) may create storage pools/volumes in the array 106 based on the data classification specifications of the user. The classifications during volume creation by a storage manager (or operator or technician) may be reliable storage or sensitive data storage.

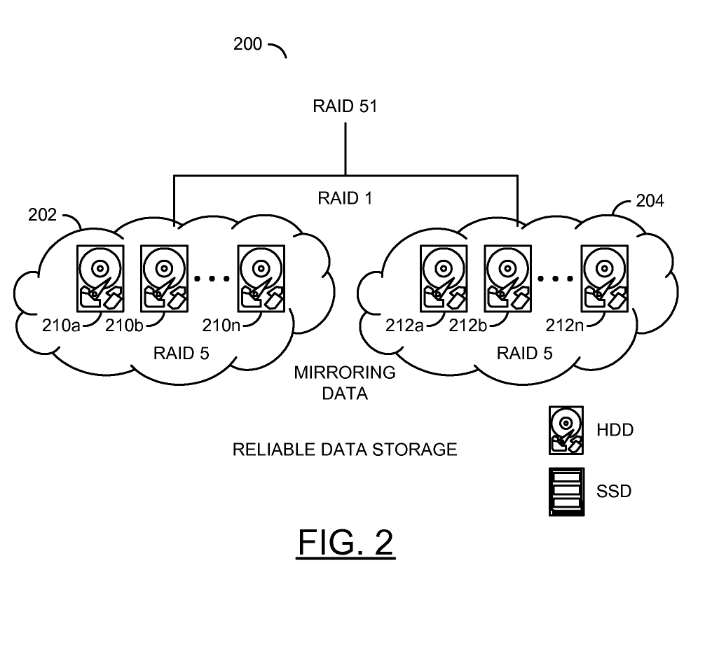

Referring to FIG. 2, a block diagram of a configuration 200 is shown illustrating a reliable data storage system. In an example implementation, the reliable storage may implement a RAID 51 or RAID 61 configuration. Other RAID configurations may be implemented to meet the criteria of a particular application. The system 200 is shown generally implementing a storage area 202 and a storage area 204. The storage areas 202 and 204 may be operated in a RAID 1 configuration. Since the configuration 200 is targeted to reliable storage, the storage area 202 may be implemented as one or more hard disk drives 210a-210n. Similarly, the storage area 204 may be implemented as a number of hard disk drives 212a-212n. The drives 210a-210n may be operated as in a RAID 5 configuration. The drives 211a-211n may also be operated as in the RAID 5 configuration.

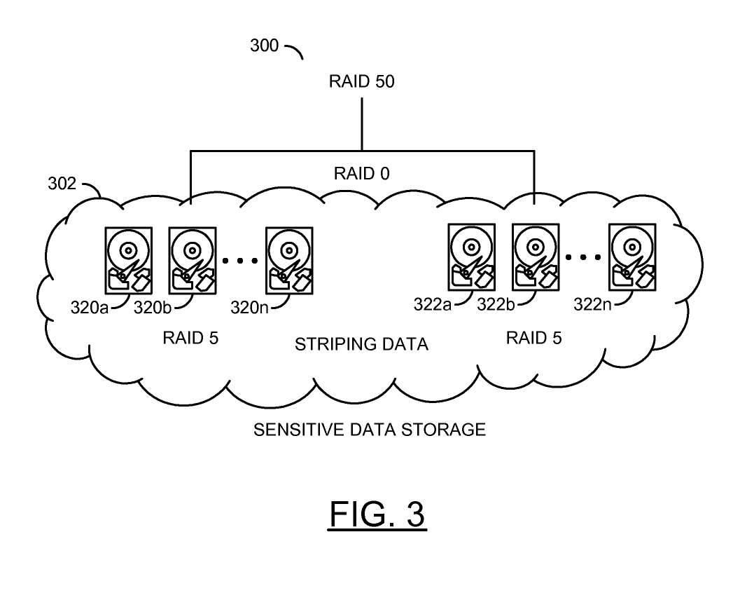

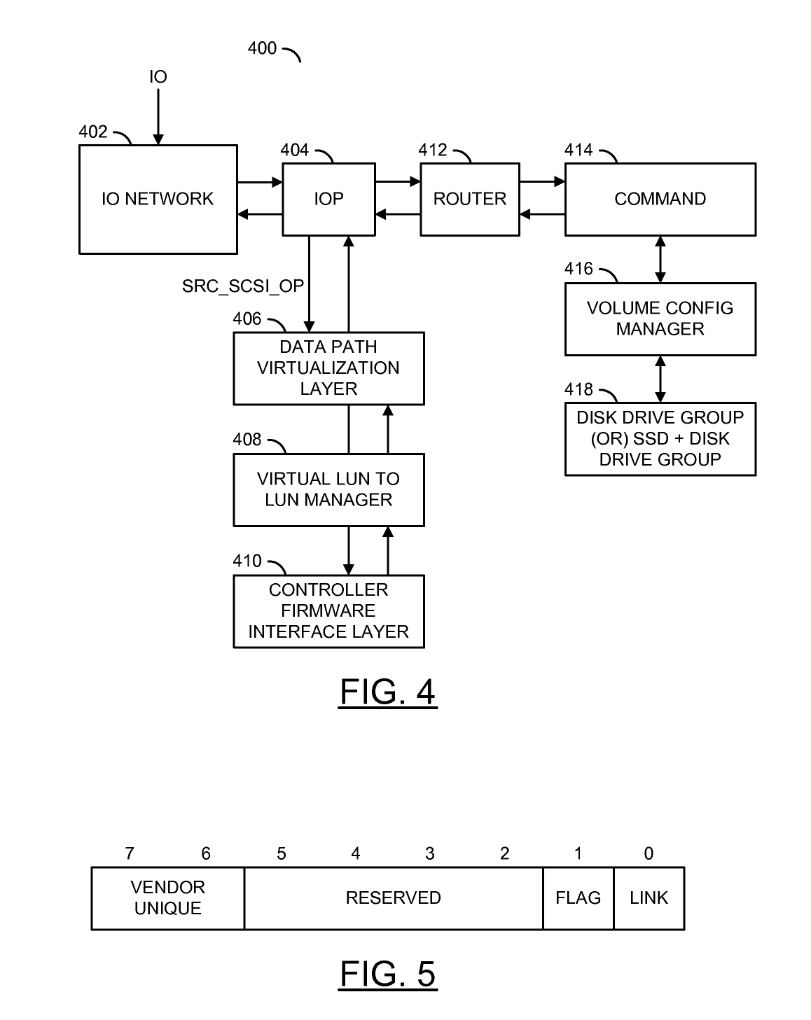

Referring to FIG. 3, a block diagram of a configuration 300 is shown illustrating a sensitive data storage system. In an example implementation, sensitive data storage may implement RAID 50 or RAID 60. Other RAID configurations may be implemented to meet the criteria of a particular application. Since the configuration 300 is directed to sensitive data storage, a storage area 302 may be implemented as a number of storage devices 320a-320n and a number of storage devices 322a-322n. The drives 320a-320n may be operated in a RAID 5 configuration. The drives 322a-322n may also be operated in a RAID 5 configuration. A group of drives that incorporates the drives 320a-320n may be operated in a RAID 0 configuration with another group of drives that incorporates the drives 322a-322n. Input/output requests from an initiating device (e.g., the host 102 via the signal REQ) may be received at the controller 108. A data path virtualization layer (to be described in more detail in connection with FIG. 4) may manage input/output requests from the host 102 to the drive groups (or volume groups) 302.

Referring to FIG. 4, a block diagram of an input/output transaction path 400 through a virtualization layer is shown. The path 400 generally comprises a block (or circuit) 402, a block (or circuit) 404, a block (or circuit) 406, a block (or circuit) 408, a block (or circuit) 410, a block (or circuit) 412, a block (or circuit) 414, a block (or circuit) 416 and a block (or circuit) 418. The circuits 402 to 418 may represent modules and/or blocks that may be implemented as hardware, software, a combination of hardware and software, or other implementations.

The circuit 402 may be implemented as an input/output (e.g., IO) network circuit. The circuit 404 may be implemented as an input/output processor circuit. The circuit 406 may be implemented as a data path virtualization circuit. The circuit 408 may be implemented as a virtual logical-unit-number (e.g., LUN) to logical-unit-number map manager circuit. The circuit 410 may be implemented as a controller firmware interface layer. The circuit 412 may be implemented as a router circuit. The circuit 414 may be implemented as a command circuit. The circuit 416 may be implemented as a volume creation manager circuit. The circuit 418 may be implemented as a disk drive group circuit.

The data path virtualization layer circuit 406 may receive SCSI input/output processes from the initiators (e.g., the host 102) and update the input/output processes with vendor unique bit information (to be described further in FIG. 5). The vendor unique bit information may be encapsulated by the circuit 406 as part of data frames or packets received from the initiators. The circuit 406 may update the SCSI input/output processes with the vendor unique bits in a block of data (e.g., CONTROL BYTES) of the input/output processes based on the data access criteria. In some embodiments, the vendor unique bit information may be stored in a SCSI command descriptor block before being presented to the router 412 located in the firmware 109. Next, the vendor unique bit information may be presented to drive or volume groups (e.g., blocks 120a-120n, 122a-122n and 124a-124n). All of the vendor unique bits may be set to “zero” (or a logical low) to indicated input/output to data reliable only drive groups or volume groups (e.g., drives 210a-210n and 212a-212n). All of the vendor unique bits may set to “one” (or a logical high) to indicate input/output to data sensitive only drive groups or volume groups (e.g., drives 320a-320n and 322a-322n). The vendor unique bits may be set to a combination of zeros and ones (e.g., 01 or 10) to indicate input/output access to data reliable and data sensitive drive groups or volume groups (e.g., blocks 120a-120n, 122a-122n and 124a-124n). The vendor unique bits may be dynamically set based on the pattern learn logic and/or the input/output bandwidth or load.

Referring to FIG. 5, a block diagram of an example of a set of vendor unique bits in the CONTROL BYTE of a SCSI command descriptor block is shown. The CONTROL BYTE generally comprises multi-bit (e.g., 2 bit) vendor field, a flag field and a link field. Unused bits within the CONTROL BYTE may be considered as reserved. The vendor field may occupy the upper most significant bits (e.g., bits 7 and 6 in the example) of the CONTROL BYTE. The link field may occupy the least significant bit (e.g., bit 0). The flag field may occupy the second to least significant bit (e.g., bit 1). Other arrangements of the fields may be implemented to meet the criteria of a particular application.

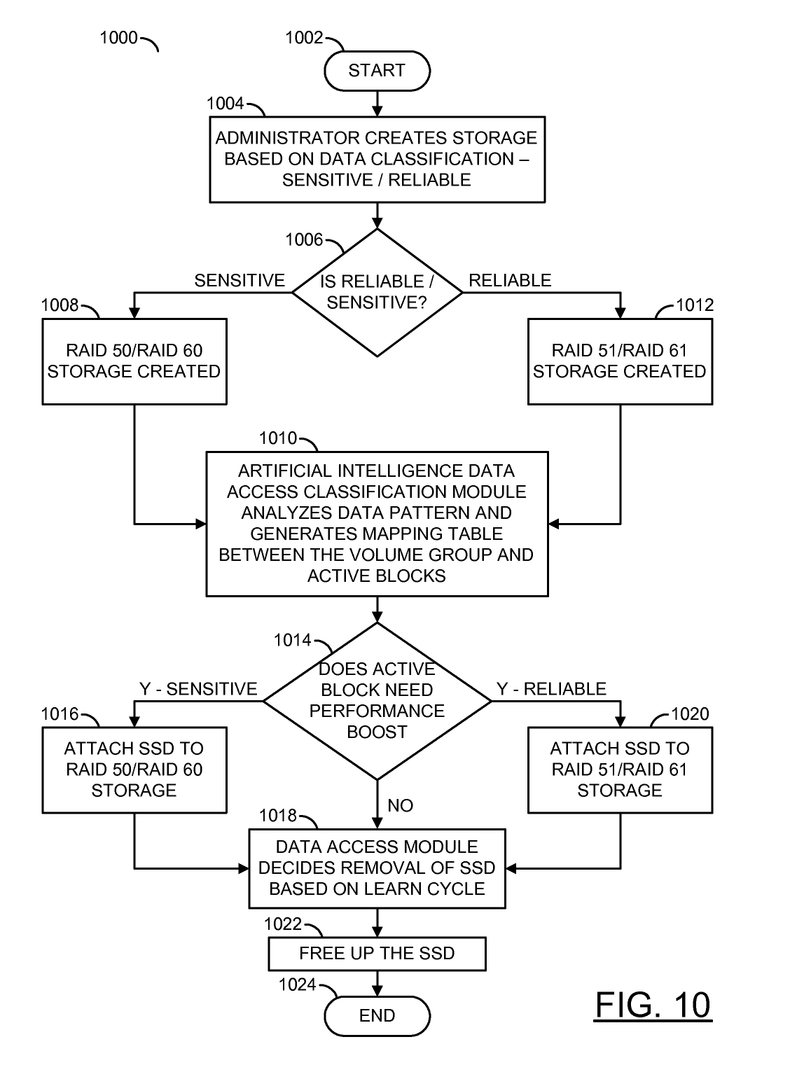

A data pattern learn logic engine (to be described in more detail in connection with FIG. 10) with data access classification may be implemented in the firmware 109. The logic engine may study the input/output patterns received based on the control byte classification. The logic engine may start monitoring a condition for faster input/output access. Pools of solid state drives 120a-120n may be kept as a global reserved cache drive group or drive pool. The learn logic normally studies why a particular category of drives (or drive groups) may be in a condition suitable for a targeted performance improvement. The learn logic may determine (i) the improvement suitable for a drive group/volume group as a whole and/or (ii) an improvement suitable for any particular drives in a drive group/volume group. The learn logic allocates a solid state drive or a set of the solid state drives 120a-120n to be mapped to the existing disk drive groups.

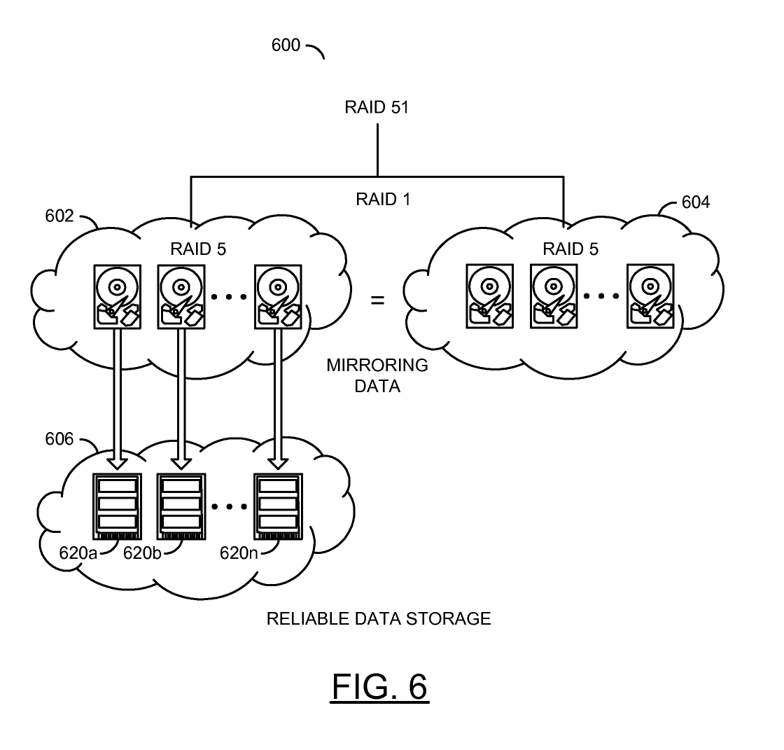

Referring to FIG. 6, a block diagram of a configuration 600 illustrating input/output transactions is shown. The configuration 600 may have a storage area 602, a storage area 604, and a storage area 606. The storage area 606 may be implemented as one or more solid state drives 620a-620n. The solid state drives 620a-620n may be implemented for individual disk drives for a performance boost. The solid state drives 620a-620n may act as another layer of cache for any particular drive (or drive group) during an input/output access. Data sent to the circuit 406 may be assigned the vendor unique bits. The command descriptor block may be updated for future input/output routing and tracking. The solid state drives 620a-620n may further boost performance of the system 100. The study of the input/output patterns may be continued by the intelligent data pattern learn logic. The study of the input/output patterns may be based on the control byte classification. If the logic determines that the input/output load or the input/output hit to any drive groups categorized for data reliability and data sensitivity is reduced, the logic may de-allocate the mapped solid state device region from the corresponding drive group. The de-allocation region may be reallocated at a later time.

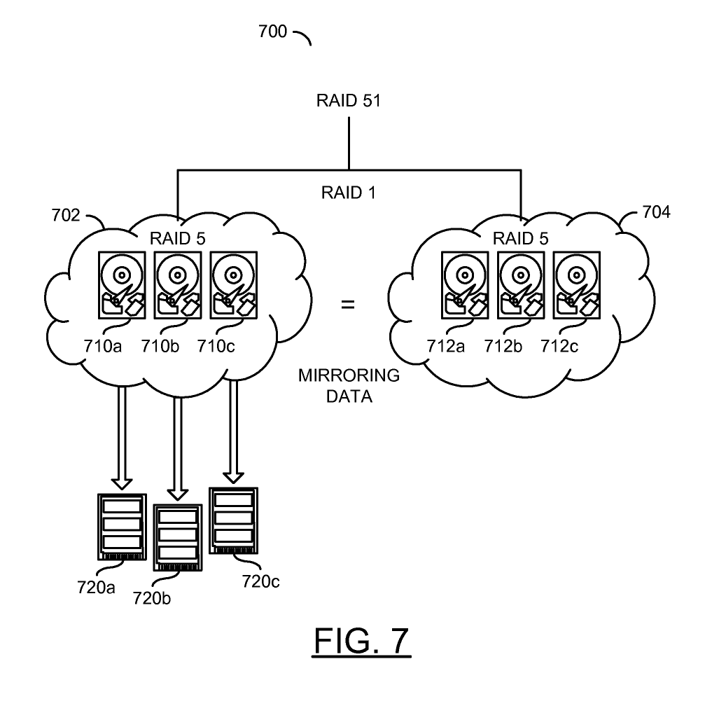

Referring to FIG. 7, a block diagram of an input/output transaction using solid state devices for disk drive groups to implement a performance boost is shown. A configuration 700 for the transaction may comprise a storage area group 702 and a storage area group 704. The group 702 and the group 704 may be arranged in a RAID 1 configuration for reliability purposes. Internally, each group 702 and 704 may be arranged in a RAID 5 configuration. Multiple solid state drives 720a-720c may be implemented to boost a performance of the drives 710a-710c in the group 702. A number of the drives 720a-720c may match a number the drives 710a-710c to maintain the same storage capacity. However, the drives 720a-720c may not have the direct one-to-one relationships with the drives 712a-712c, as illustrated in FIG. 6. In some embodiments, additional solid state drives may be implemented to boost a performance of the drives 712a-712c in the group 704. Other configurations may be implemented to meet the criteria of a particular application.

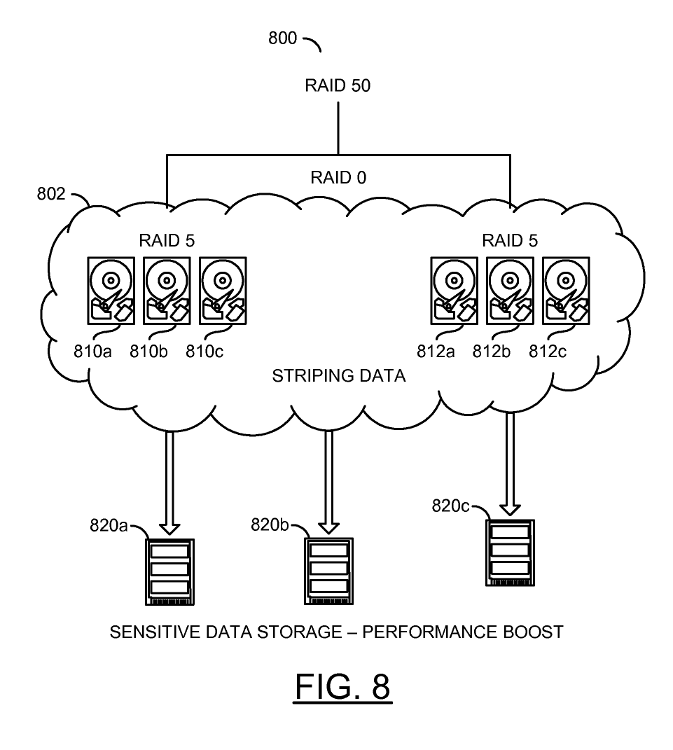

Referring to FIG. 8, a block diagram of an input/output transaction using solid state drives for mirrored disk drive groups as a whole to implement a performance boost is shown. A configuration 800 for the transaction may comprise a storage area group 802. The storage area group 802 may implement a RAID 0 configuration for sensitive data storage. The drives 810a-810c may be arranged in a RAID 5 configuration. The drives 812a-812c may be arranged in another RAID 5 configuration. Multiple solid state drives 820a-820c may be implemented to boost a performance of the drives 810a-810c and 812a-812c in the group 802. The drives 820a-820c may have a one-to-many relationship with the drives 810a-810c and 812a-812c. Other configurations may be implemented to meet the criteria of a particular application.

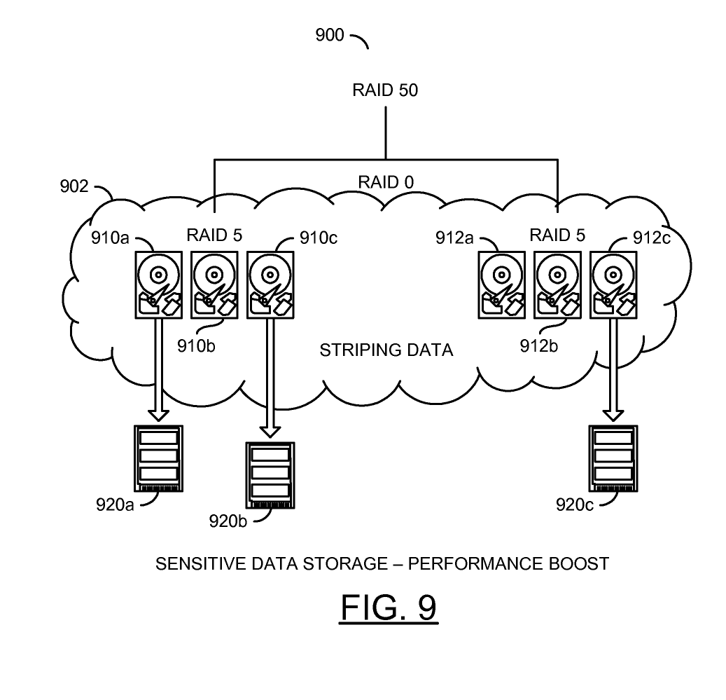

Referring to FIG. 9, a block diagram of an input/output transaction using solid state drives for individual disk drives and mirrored disk drive group as a whole to implement a performance boost is shown. A configuration 900 for the transaction may comprise a storage area group 902. The storage area group 902 may implement a RAID 0 configuration for sensitive data storage. The group 902 may comprise multiple drives 910a-910c and multiple drives 912a-912c. The drives 910a-910c may be arranged in a RAID 5 configuration. The drives 912a-912c may be arranged in another RAID 5 configuration. One or more solid state drives 920a-920c may be implemented to boost a performance of the group 902. The drives 920a-920c may have a one-to-one relationship with a subset of the drives within the group 902. For example, the drive 920a may be coupled to the drive 910a. The drive 920b may be coupled to the drive 910c. Furthermore, the drive 920c may be coupled to the drive 912c. Other configurations may be implemented to meet the criteria of a particular application.

Referring to FIG. 10, a method (or process) 1000 is shown illustrating how a data access classification is made. The method 1000 also shows how the solid state drives 120a-120n may be allocated to existing disk groups based on a number of learn cycles. The method 1000 generally comprises a step (or state) 1002, a step (or state) 1004, a decision step (or state) 1006, a step (or state) 1008, a step (or state) 1010, a step (or state) 1012, a decision step (or state) 1014, a step (or state) 1016, a step (or state) 1018, a step (or state) 1020, a step (or state) 1022 and a step (or state) 1024.

The state 1002 may be implemented as a start state. The state 1004 may be implemented to allow an administrator (or operator or technician) to create storage based on a data classification. For example, the storage may be created based on sensitive data versus reliable data. Next, the decision state 1006 generally determines if the data is reliable/sensitive. If the data is sensitive, the method 1000 generally moves to the state 1008. The state 1008 may configure the storage as a RAID 50 or RAID 60 storage device. Next, the method 1000 may move to the state 1010. If the state 1006 determines that the data is intended to be reliable data, the method 1000 generally moves to the state 1012. In the state 1012, the method 1000 may configure the storage array as a RAID 51 or RAID 61 storage device and the method 1000 may move to the state 1010. The state 1010 may analyze a data pattern and generates a mapping table between the volume group and the active blocks. Next, the method 1000 may move to the decision state 1014. The decision state 1014 generally determines if an active block may benefit from a performance boost. If an active block may benefit from the performance boost and the data is sensitive data, the state 1016 generally attaches a solid state device the RAID 50/RAID 60 storage. If active block may benefit from the performance boost and the data is reliable data, the method 1000 may attache a solid state device to the RAID 51/RAID 61 storage in the state 1020. If the active block may not benefit from a performance boost, the method 1000 may move to the state 1018. In the state 1018, a data access module generally decides whether removal of one or more of the solid state devices may be appropriate based on a learn cycle. Next, the state 1022 frees up the solid state device identified in the state 1020. Next, the state 1024 ends the process.

Implementation of a neural network may provide a possibility of learning. Given a specific task to solve and a class of functions, the learning may involve using a set of observations to find functions and/or relations that solves the tasks in an optimal sense. A machine learning method may involve a scientific discipline concerned with the design and development of techniques that may allow computers to evolve behaviors based on empirical data, such as from sensor data or databases. Artificial neural networks may comprise mathematical models or computational models inspired by structural and/or functional aspects of biological neural network. Cluster analysis (or clustering) may be the assignment of a set of observations into subsets (call clusters) so that observations in a same cluster may be similar in some sense. Clustering may be a technique (or method) of unsupervised learning and a common technique for statistical data analysis.

In some embodiments, the smart data access classification may be based on artificial intelligence. An artificial intelligence based smart data classification module generally performs the data pattern analysis based on an artificial neural network computation module. The artificial neural network computation model generally forms a cluster for data utilizing the sensitive/reliable storage over a learning time (e.g. Tₗₑₐᵣₙ). The computation model may classify the volume group/disk/active blocks under the categories. Some artificial neural networks, such as a self-organizing map (e.g., SOM) network, may be used to cluster the data automatically. Thereafter, the high-performance data may be viewed as one of the clusters.

The data pattern analysis may be a three-dimensional computation where the learning is done based on the following criteria:

1) Analyzing the input/output data coming to a volume group in the storage subsystem behind the controller 108.

2) A next level of data pattern analysis may be performed based on the input/output transfers reaching the target physical drives and the blocks that are active during the input/output transfer.

3) A table may be built during the learning cycle with the column group versus the drive versus the active blocks.

4) Based on the high activity blocks that may be available, clusters may be created for (i) high input/output processes for sensitive blocks and (ii) average input/output processes for reliable blocks using unsupervised cluster analysis method.

5) The learning cycle may be dynamic and self-defined based on the patterns and a consistency of the patterns to derive a relationship between the active blocks and the input/output transfers.

An example of multiple (e.g., N) learning cycles per multiple (e.g., three) active volume groups is generally illustrated in Table I as follows:

TABLE I

| | | Learning Cycle | | | | | | |
|---|---|---|---|---|---|---|---|---|
| | | T1 | T2 | T3 | T4 | T5 | . . . | Tn |
| Volume | Volume | Ac- | | | | | | |
| Group | Group 1 | tive | | | | | | |
| | Volume | | | | | | | |
| | Group 2 | | | | | | | |
| | Volume | | Ac- | Ac- | Ac- | Ac- | Ac- | Ac- |
| | Group 3 | | tive | tive | tive | tive | tive | tive |

An example of the multiple learning cycles per physical drive (e.g., PD) is generally illustrated in Table II as follows:

TABLE II

| | | Learning Cycle | | | | | | |
|---|---|---|---|---|---|---|---|---|
| | | T1 | T2 | T3 | T4 | T5 | . . . | Tn |
| Volume | Volume | PD1, PD2, | | | | | | |
| Group | Group 1 | PD3 | | | | | | |
| | Volume | | | | | | | |
| | Group 2 | | | | | | | |
| | Volume | | PD13 | PD12 | PD12, | PD11, | PD11, | PD11, |
| | Group 3 | | | | PD13 | PD12 | PD12 | PD12 |

An example of the learning cycles per active blocks (e.g., B) is generally illustrated in Table III as follows:

TABLE III

| | | Learning Cycle | | | | | | |
|---|---|---|---|---|---|---|---|---|
| | | T1 | T2 | T3 | T4 | T5 | . . . | Tn |
| Volume | Volume | B1, B11, | | | | | | |
| Group | Group 1 | B23 | | | | | | |
| | Volume | | | | | | | |
| | Group 2 | | | | | | | |
| | Volume | | B23, | B23, | B23, | B27 | B27 | B27 |
| | Group 3 | | B27 | B27 | B27 | | | |

As per the tables, the data classification module generally identifies the blocks utilizing the high input/output process storage. The data classification module may also decide among the blocks based on the active volume groups, the physical drives and the active blocks.

The system 100 may implement a user option to select multiple (e.g., three) different levels of data storage access. The different levels may include, but are not limited to, (i) sensitive data storage, (ii) reliable data storage and (iii) reliable and sensitive data storage. The system 100 may allocate and/or de-allocating a number of solid state drives 120a-120n to act as temporary cache layers to a disk drive group/volume group by a learn logic engine based on input/output load requirements. The system 100 may provide (i) easy and efficient storage planning based on data access criteria of the user, (ii) better reliability, (iii) dynamic performance boost and/or (iv) a cost versus performance advantage. Usage of hybrid drives with NAND flash memory integrated for disk caching may further boost the performance. The system 100 may be implemented for (i) web service and Internet service providers (e.g., ISPs), (ii) database applications, (iii) military applications, (iv) high performance computing applications and/or (v) image processing applications.

The functions performed by the diagram of FIG. 10 may be implemented using one or more of a conventional general purpose processor, digital computer, microprocessor, microcontroller, RISC (reduced instruction set computer) processor, CISC (complex instruction set computer) processor, SIND (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMS (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. A method for configuring resources in a storage array, comprising the steps of:
(a) determining if a data access is a first type or a second type;
(b) if said data access is said first type, configuring said storage array as a reliable type configuration; and
(c) if said data access is said second type, configuring said storage array as a secure type configuration.

2. The method according to claim 1, wherein said reliable type configuration comprises a RAID 51 configuration.

3. The method according to claim 1, wherein said reliable type configuration comprises a RAID 61 configuration.

4. The method according to claim 1, wherein said secure type configuration comprises a RAID 50.

5. The method according to claim 1, wherein said secure type configuration comprises a RAID 60.

6. The method according to claim 1, further comprising:
generating a mapping table between one or more volume group and active blocks.

7. The method according to claim 6, further comprising the step of:
determining whether an active block needs a performance boost.

8. The method according to claim 7, further comprising:
attaching a solid state device to said reliable type configuration or said secure type configuration.

9. The method according to claim 8, further comprising:
after an initial access determining whether said solid state device may be removed to free up said solid state device.

10. The method according to claim 9, wherein said data access comprises writing to a hard disc device, reading from said solid state device and synchronizing said hard disc device with said solid state device asynchronously after said data access.

11. The method according to claim 1, wherein said storage array comprises a RAID configuration.

12. The method according to claim 11, wherein said method is implemented on a RAID controller.

13. An apparatus comprising:
a storage array; and
a circuit configured to (i) determine if a data access is a first type or a second type, (ii) if said data access is said first type, configure said storage array as a reliable type configuration and (iii) if said data access is said second type, configure said storage array as a secure type configuration.

14. The apparatus according to claim 13, wherein said circuit is further configured to (i) determine if said data access is a third type and (ii) if said data access is said third type, configure said storage array as both said reliable type configuration and said secure type configuration.

15. The apparatus according to claim 13, wherein said circuit is further configured to determine whether an active block needs a performance boost.

16. The apparatus according to claim 15, wherein said circuit is further configured to attach one or more solid state devices to said reliable type configuration or said secure type configuration to achieve said performance boost.

17. The apparatus according to claim 16, wherein said circuit is further configured to determine whether at least one of said solid state devices may be removed to free up said solid state device after an initial access.

18. The apparatus according to claim 13, wherein said circuit comprises a controller circuit and said storage array comprises a RAID array.

19. The apparatus according to claim 13, wherein said apparatus is implemented as one or more integrated circuits.

20. An apparatus comprising:
means for determining if a data access is a first type or a second type;
means for configuring a storage array as a reliable type configuration if said data access is said first type; and
means for configuring said storage array as a secure type configuration if said data access is said second type.
